(19) United States
(12) Patent Application Publication
(10) Pub. No.: US 2024/0039691 A1
(43) Pub. Date: Feb. 1, 2024

(54) MANAGEMENT OF ACCURATE SCALES IN FULLY-HOMOMORPHIC ENCRYPTION SCHEMES

(71) Applicant: International Business Machines Corporation, Armonk, NY (US)

(72) Inventors: GILAD EZOV, Nesher (IL); EHUD AHARONI, Kfar Saba (IL); OMRI SOCEANU, Haifa (IL); ALLON ADIR, Kiryat Tivon (IL)

(21) Appl. No.: 17/873,220

(22) Filed: Jul. 26, 2022

(51) Int. Cl. H04L 9/00; H04L 9/06; G06N 3/08

(52) U.S. Cl. CPC H04L 9/008; H04L 9/0618; G06N 3/08

(57) ABSTRACT

A computer-implemented method including, in a fully-homomorphic encryption (FHE) scheme that employs ciphertext rescaling at different levels of a modulus chain of prime numbers: initializing a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

### BACKGROUND

The invention relates to the field of computerized cryptography, particularly fully-homomorphic encryption.

Fully-homomorphic encryption (FHE) is a type of encryption that allows computations to be made on encrypted data (“ciphertext”) without first decrypting them. These computations will yield the same results, when decrypted, as if they were performed on the same data in its unencrypted form (“plaintext”).

There are also some approximated FHE schemes which, in favor of efficiency, integrally generate some noise (error) and thus yield approximately the same results—but not exactly the same results—as if performed directly on the plaintext. One such scheme is the well-known CKKS scheme, proposed by Jung Hee Cheon, Andrey Kim, Miran Kim, and Yongsoo Song, “Homomorphic Encryption for Arithmetic,” in ASIACRYPT 2017, Part I, LNCS 10624, pp. 409-437, 2017.

In FHE, generally, the encryption scheme includes an encryption operation that encrypts a vector of some fixed size, creating a ciphertext. Following computation, a decryption operation then retrieves the data from the resulting ciphertext. The encryption scheme generally ensures that any computations performed on the encrypted data will yield the same or approximately the same results as applying the same computations to the underlying unencrypted data.

This separation between encryption/decryption and computation makes FHE particularly useful when computation of personal or sensitive data has to be outsourced to an entity or location where their secrecy cannot be guaranteed. Such personal or sensitive data can be first encrypted using homomorphic encryption, and then transmitted (for example, to commercial cloud environment) for processing, all while encrypted. The results of the computations, still in an encrypted form, are then provided back to the original sender, who can decrypt them in a safe environment and observe the results. This procedure diminishes privacy and other secrecy concerns, as the unencrypted data is never made available to the entity performing the computations, and naturally also not to any malicious third party who manages to compromise that entity's computer storage or intercept the transmissions between that entity and the original sender.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a computer-implemented method comprising, in a fully-homomorphic encryption (FHE) scheme that employs ciphertext rescaling at different levels of a modulus chain of prime numbers: initializing a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

Another embodiment provides a system comprising: (a) at least one hardware processor; and (b) a non-transitory computer-readable storage medium having program code embodied therewith, the program code executable by said at least one hardware processor to: operate a fully-homomorphic encryption (FHE) scheme that employs ciphertext rescaling at different levels of a modulus chain of prime numbers; and initialize a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

A further embodiment provides a computer program product comprising a non-transitory computer-readable storage medium having program code embodied therewith, the program code executable by at least one hardware processor to: operate a fully-homomorphic encryption (FHE) scheme that employs ciphertext rescaling at different levels of a modulus chain of prime numbers; and initialize a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

In some embodiments, the FHE scheme is CKKS.

In some embodiments, the value to which the scale of the highest level of the modulus chain is initialized further equals: a multiplication of: (a) an arithmetic product of the prime numbers, each to the power of two, to the power of: the location of the respective prime number in the modulus chain, minus one, by: (b) one divided by: two to the power of: the location of the respective prime number in the modulus chain, minus one.

In some embodiments, the method further comprises, or the program code is further executable for: obtaining the prime numbers of the modulus chain from a software library that implements the FHE scheme, wherein the initialization is performed responsive to the obtaining.

In some embodiments, the method further comprises, or the program code is further executable for: calculating scales for all levels of the modulus chain which are lower than the highest level, based on the initialized scale of the highest level.

In some embodiments, the method further comprises, or the program code is further executable for performing at least one of: (a) according to the calculated scales, rescaling the ciphertexts at one or more levels of the modulus chain which are lower than the highest level, wherein, due to the initialization, the calculated scales are maintained within a range of values of the prime numbers; and (b) responsive to encryption of a plaintext into a ciphertext at a certain level of the modulus chain, associating the encrypted ciphertext with the calculated scale of that certain level.

In some embodiments, the method further comprises, or the program code is further executable for: obtaining machine learning data that comprise: (a) a trained artificial neural network (ANN), and one or more test samples, or (b) an untrained ANN, and a training set; encrypting at least some of the machine learning data using the FHE scheme; and performing, respectively: (a) encrypted inference by the trained ANN, or (b) encrypted training of the untrained ANN.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates examples of rules relating to arithmetic operations performed on scaled ciphertexts.

FIG. 2 illustrates naïve rescaling of a ciphertext upon transitioning to a lower level on a modulus chain.

FIG. 3 illustrates rescaling of a ciphertext upon transitioning to a lower level on a modulus chain, according to the “accurate scales” approach.

FIG. 4 shows a block diagram of an exemplary computing environment for the execution of computer program code involved in performing ciphertext scale initialization.

FIG. 5 shows a flowchart of a method for initializing a ciphertext scale in an FHE scheme that employs ciphertext rescaling at different levels of a modulus chain of primes.

### DETAILED DESCRIPTION

Disclosed herein is a computer-implemented method, also embodied as a system and a computer program product, for initializing a scale of the highest level of a modulus chain of an FHE scheme to a value that ensures, advantageously, that any ciphertext rescaling operations performed at lower levels of the modulus chain do not yield scales of computationally-impractical magnitudes. For example, the scales may be maintained, when the method is utilized, within the range of the highest and lowest prime numbers of the modulus chain.

The disclosed method may be applicable to, and performed within the framework of, FHE schemes that employ ciphertext rescaling at different levels of a modulus chain of prime numbers. One prominent example is the well-known CKKS scheme. The disclosed method may apply to any similar FHE scheme introduced in the future.

Ciphertext scaling exists in various FHE schemes, including CKKS, to support the representation of ciphertexts as whole numbers (integers) instead of as fractions. For example, an original ciphertext value of 0.8 may be represented as a value of 800, with an associated scale of 1000 stored therewith. This means that, to deduce the original value of the 800 ciphertext, it should be divided by the scale value, 1000.

These FHE schemes have certain rules for arithmetic operations performed between ciphertexts of different or same scales. Addition is possible only between ciphertexts of the same scale. If adding ciphertexts of different scales is required, these are first adjusted (rescaled) to use the same common ‘denominator’ (scale), and only then added. On the other hand, multiplication is allowed also between ciphertexts of different scales, and involves multiplying both the ciphertexts and their scales, such that the resulting ciphertext is stored with a scale which is the product of the multiplied scales.

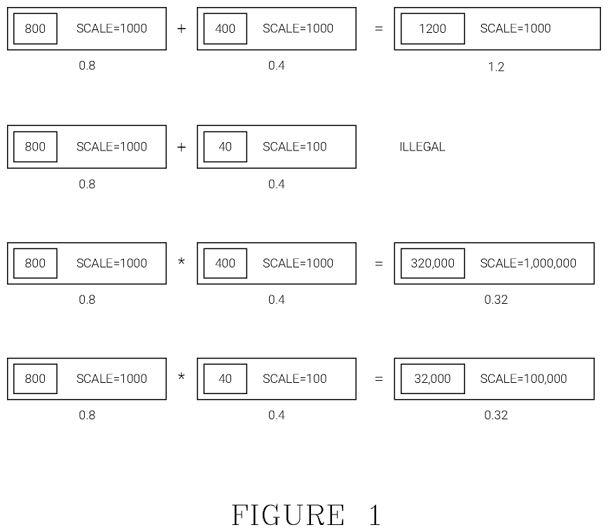

FIG. 1 shows a few simplistic examples of these rules, such as: permitted addition and multiplication of the ciphertexts 800 and 400 that share the same scale, 1000; forbidden addition of the ciphertexts 800 (scale 1000) and 40 (scale 100); and the permitted multiplication of the ciphertexts 800 (scale 1000) and 40 (scale 100). The original (fractional) ciphertexts of these ciphertexts (e.g., 0.8, 0.4) is shown underneath them in the figure.

Rescaling is performed not only when the addition of different-scale ciphertexts is required, but also (and mainly) when transitioning a ciphertext to a lower level on the modulus chain. The latter is typically performed to prevent the scales from uncontrollably growing, because larger scales mean more complex and lengthy computations. Each level on the modulus chain may include multiple arithmetic operations between ciphertexts, whose resulting ciphertext is typically of a higher scale than any of these individual ciphertexts. Hence, when computations at a certain level of the modulus chain finish, the scale of the resulting ciphertext is often larger than the original(s). If nothing is done to control this growth of the scales, they might reach magnitudes which are computationally prohibitive after a certain number of modulus chain levels.

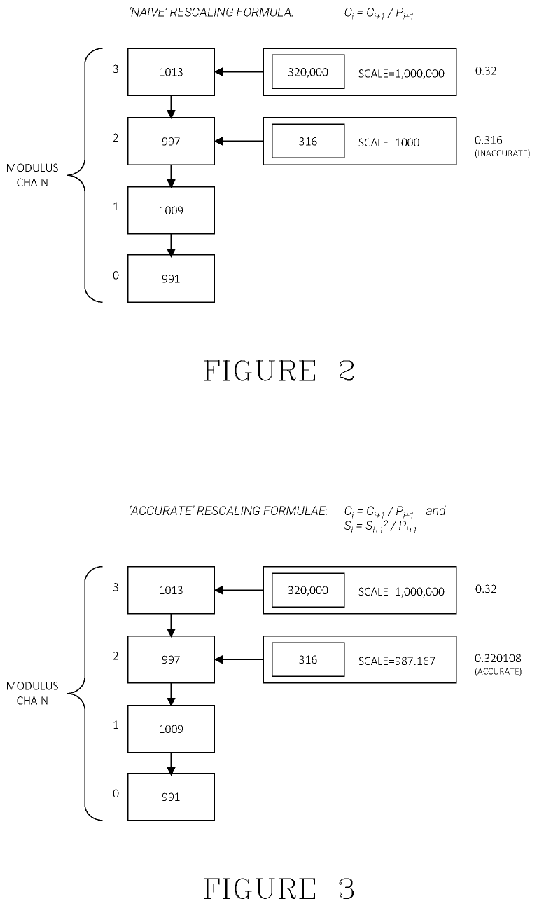

Reference is made to FIG. 2 which illustrates ciphertext rescaling (without yet showing the effects of scale growth). The modulus chain, indexed by 0 . . . N (N being the highest level of the chain), includes a series of primes initialized by the software library implementing the FHE scheme, as is known in the art. These primes are typically the closest primes to the value of a desired default scale, manually provided or automatically decided upon at the beginning of the FHE scheme operation. In this example, the default scale is 1000, and its closest primes are 1013, 997, 1009, and 991. This is a simplistic example, of course, with practical modulus chains typically including much higher primes, often in the realm of millions or even billions, as well as a greater number of levels, often a few tens of levels or even more.

As illustrated in this figure, rescaling upon transitioning to the subsequently-lower level of the modulus chain (to prevent the scales from gradually increasing) involves calculating the rescaled ciphertext according to

Cᵢ=Cᵢ₊₁/Pᵢ₊₁, (1)

where i is the level index, C is the ciphertext and P is the prime. Accordingly, when naively rescaling 320,000 from a scale of 1,000,000 to the default scale of 1000, the calculation will in fact be based on division by the prime of level 3, which is 1013: C₂= 320,000/1013=315.893385982231. This value is rounded to the closest integer, 316. The underlying (unscaled) value of this ciphertext is 0.316 ( 316/1000), which clearly deviates from the correct value of 0.32, seen in the highest (fourth) level of the chain. Certain FHE software libraries take this naive approach, and sacrifice accuracy in favor of scale management simplicity.

A more intelligent approach, sometimes referred to as “accurate scales” or “RE (Reduced-Error) CKKS,” still involves dividing the ciphertext by the pertinent prime, but stores with it a scale value that will compensate for the above-mentioned inaccuracy caused by the primes. This approach is presented in Andrey Kim, Antonis Papadimitriou, and Yuriy Polyakov, “Approximate Homomorphic Encryption with Reduced Approximation Error,” Cryptology ePrint Archive, Paper 2020/1118, 2021. FIG. 3 illustrates a simplistic example of this approach. To rescale the ciphertext 320,000 (scale 1,000,000), it is divided by the prime 1013 (according to formula 1), but then stored with an associated scale of 987.167 (instead of the default 1000), such that the result of 316 (with a scale of 987.167) has the underlying value 0.320108, almost equal to the correct value of 0.32. The value of the scale to be stored with the rescaled ciphertext, 987.167, is calculated by a second formula:

Sᵢ=Sᵢ₊₁²/Pᵢ₊₁, (2)

where i is the level index, S is the ‘accurate’ scale and P is the prime.

However, in relatively deep modulus chains, such as chains with more than 15, 20, 25, 30, 35, or 40 levels, the scale calculation formula sometimes yields, at the lower levels of the chain, scale values that are either too high (approaching towards infinity) or too low (decaying towards zero) for a computer to handle. This is also acknowledged by Kim (2020), for example on page 3, second paragraph; page 4, last paragraph; and page 18, following the subtitle “Choosing the Primes to Avoid the Divergence of Scaling Factors.” Very high scales are difficult to handle computationally (requiring lengthy, impractical computation times), and very low scales again introduce inaccuracies (if they are low but not too low to be computationally handled), because a low scale, together with an integer ciphertext, inherently means substantial rounding; the scales might also be so low that they simply cannot be handled computationally. Kim (2020) proposed to solve this problem using one of three algorithms (see pages 18-20) that select the primes for the modulus chain; these algorithms are said to either “[minimize] the difference between Δ [symbol] and 2^{p},” or “minimize the difference between two subsequent scaling factors.”

An illustrative example of this problem is shown in Table 1, which lists the primes and the scales for a 26-level deep modulus chain.

The scale at the highest level (index 25) of this exemplary chain has been initialized to 1,073,741,824, given a default scale selection (by a user or automatically by the software library executing the FHE scheme) of 2³⁰. Subsequently, the scales at the lower levels have been calculated based on the ‘accurate scales’ formula given above. As can be seen, exponential growth of the scales begins as early as index 13, and the scale at level 5 already reaches 7.8102×10²⁸³, a number too large to be handled computationally in any reasonable amount of time, and even completely incalculable using today's computers. The subsequent lines in the table, of indices 4 through 0, even show an error message (#NUM!), which is how the spreadsheet software used to calculate the scales in this example indicates that it simply cannot calculate such high numbers. A similar problem arises with very small numbers, fractions with numerous digits to the right of the decimal point. Such small numbers are also incalculable using today's computers.

TABLE 1
A 26-level deep modulus chain exhibiting
exponential growth of scales

| Chain index | Prime | Scale |
|---|---|---|
| 25 | 1072721921 | 1073741824 |
| 24 | 1073692673 | 1074762697 |
| 23 | 1073508353 | 1075833787 |
| 22 | 1073213441 | 1078164258 |
| 21 | 1072521217 | 1083137913 |
| 20 | 1073479681 | 1093859702 |
| 19 | 1072291841 | 1114626638 |
| 18 | 1072488449 | 1158632841 |
| 17 | 1071861761 | 1251696521 |
| 16 | 1073668097 | 1461703587 |
| 15 | 1072459777 | 1989979383 |
| 14 | 1072254977 | 3692462906 |
| 13 | 1073233921 | 12715522525 |
| 12 | 1073299457 | 1.50652E+11 |
| 11 | 1072537601 | 2.11459E+13 |
| 10 | 1073430529 | 4.16909E+17 |
| 9 | 1072705537 | 1.61923E+26 |
| 8 | 1072496641 | 2.44421E+43 |
| 7 | 1071751169 | 5.57034E+77 |
| 6 | 1073184769 | 2.8951E+146 |
| 5 | 1072115713 | 7.8102E+283 |
| 4 | 1073655809 | #NUM! |
| 3 | 1073569793 | #NUM! |
| 2 | 1072611329 | #NUM! |
| 1 | 1072078849 | #NUM! |
| 0 | | #NUM! |

Advantageously, the ciphertext scale initialization according to the present method overcomes this problem. The scale of the highest level in the chain is initialized to a certain special number, further discussed below, which ensures that the scales of the lower levels (calculated based on the scale of the highest level) will remain computationally manageable, such as within the range of the highest and lowest primes of the modulus chain.

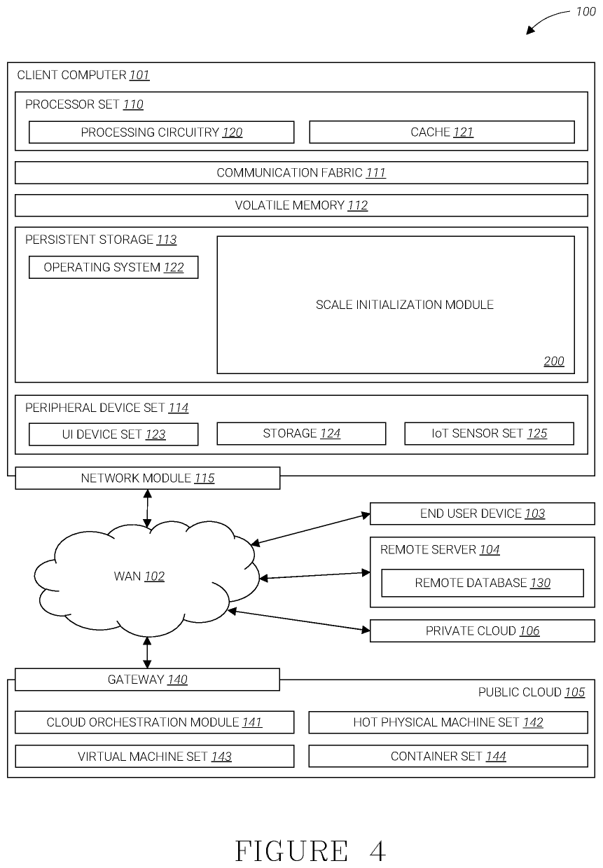

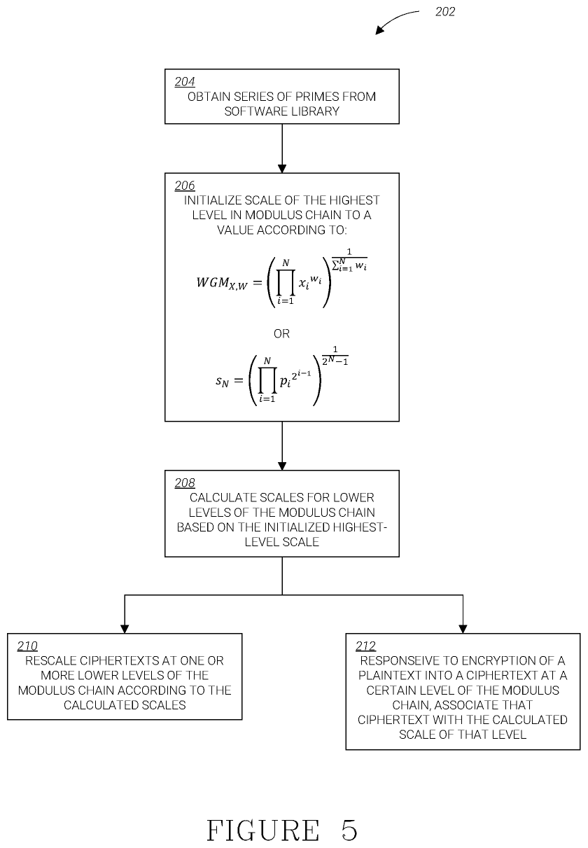

Reference is now made to FIG. 4, which shows a block diagram of an exemplary computing environment 100, containing an example of an environment for the execution of at least some of the computer program code involved in performing the inventive methods, such as code included in a scale initialization module 200. In addition to module 200, computing environment 100 includes, for example, a computer 101, a wide area network (WAN) 102, an end user device (EUD) 103, a remote server 104, a public cloud 105, and/or a private cloud 106. In this example, computer 101 includes a processor set 110 (including processing circuitry 120 and a cache 121), a communication fabric 111, a volatile memory 112, a persistent storage 113 (including an operating system 122 and module 200, as identified above), a peripheral device set 114 (including a user interface (UI), a device set 123, a storage 124, and an Internet of Things (IoT) sensor set 125), and a network module 115. Remote server 104 includes a remote database 130. Public cloud 105 includes a gateway 140, a cloud orchestration module 141, a host physical machine set 142, a virtual machine set 143, and a container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in module 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as a network interrace controller (NIC), a modem, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through the hardware included in network module 115.

WAN 102 is any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The instructions of ciphertext scale initialization module 108 are now discussed with reference to the flowchart of FIG. 5, which illustrates a method 202 for initializing (setting) a ciphertext scale in an FHE scheme that employs ciphertext rescaling at different levels of a modulus chain of primes.

Steps of method 202 may either be performed in the order they are presented or in a different order (or even in parallel), as briefly mentioned above, as long as the order allows for a necessary input to a certain step to be obtained from an output of an earlier step. In addition, the steps of method 202 are performed automatically (e.g., by computer 101 of FIG. 1, or by any other applicable component of computing environment 100), unless specifically stated otherwise.

In a step 204, a series of the primes of the modulus chain may be obtained from a software library that implements the FHE scheme. Examples of prominent software libraries include HElayers, by International Business Machines Corporation, Armonk, New York; HEAAN, an open source project maintained by the cryptography lab at the Seoul National University, South Korea; and SEAL, by Microsoft Corporation, Redmond, Washington.

Optionally, method 202 is implemented as part of such software library (e.g., as one or more functions or components inside the library), in which case the primes may be obtained from the component or function of the software library that instantiated them.

In either case, method 202 does not include and does not necessitate any manipulation of the series of primes generated by the pertinent software library. Rather, the next step (206) is performed given whatever primes were provided by the software library. This, advantageously, avoids the complexity of various prior techniques that necessitated adjusting each of the provided primes, or having the software library generate uniquely-crafted primes using some resource-intensive calculations. In some scenarios, even if the computational overhead of adjusting or crafting the primes is not too high, the pertinent software library may not at all permit making any changes to the primes it instantiates, or allow them but require manual labor and expert knowledge by the user.

In a step 206, responsive to the obtaining of the primes, a scale (also ciphertext scale) of the highest level of the modulus chain may be initialized to a special value that ensures that the scales of the lower levels will remain computationally manageable, such as within the range of the highest and lowest primes of the modulus chain.

That special value optionally equals a weighted geometric mean of all the primes, calculated according to:

$${WGM}_{X , W} = {( {\prod }_{i = 1}^{N} {x}_{i}^{{w}_{i}} )}^{\frac{1}{{\sum }_{i = 1}^{N} {w}_{i}}} \qquad ( 3 )$$

where:
X={p₁, p₂, . . . , p_{N}},
W={1, 2, 4, 8, . . . , 2^{N-1}}, and
S_{N}=WGM_{X,W}.

Namely, the series of primes is regarded as the series of samples, and the series {1, 2, 4, 8, . . . , 2^{N-1}} is regarded as the weights of these primes. The weighted geometric mean is then used as the value to which the scale of the highest level (S_{N}) is initialized.

Put differently, in the weighted geometric mean, the weight for each of the primes is two to the power of: a location of the respective prime number in the modulus chain, minus one.

Another way to look at that special value is that it equals:

$${s}_{N} = {( {\prod }_{i = 1}^{N} {p}_{i}^{{2}^{i - 1}} )}^{\frac{1}{{2}^{N} - 1}} \qquad ( 4 )$$

where i is the index location of the primes in the obtained series, p is a prime, and Nis the index of the highest level of the modulus chain (note that in this formula, contrary to the examples in FIGS. 3 and 4, the index begins at 1).

Put differently, S_{N} may be equal a multiplication of (a) an arithmetic product of the prime numbers, each to the power of two, to the power of: the location of the respective prime number in the modulus chain, minus one, by (b) one divided by: two to the power of: the location of the respective prime number in the modulus chain, minus one.

An example of a highest-level scale calculated for a 41-level deep modulus chain is shown in Table 2 (in which data for chain indices 6 through 34 is omitted for reasons of simplicity). As this table shows, the calculation according to either formula 3 or 4, for the particular series of primes, yields a scale value of 1,073,672,522.50147 for the highest level in the chain. The subsequently-calculated scales then remain steady along the lower levels, reaching a reasonable, manageable value of 1,073,249,520 at the lowest level (index 0). It can also be seen that all the scales are maintained within, and do not exceed, the range of the primes (between 1,073,692,673 and 1,071,751,169).

The calculation should be followed precisely, as any rounding might yields unmanageably high or low scales following multiplications along multiple levels of the chain. For instance, Table 3 shows an example in which that value was rounded up to the closest integer, and Table 4 shows an example in which that value was rounded down to the closest integer. In both cases, the scales deviated sharply up or down, respectively, starting approximately at index 4 or 5. At index 0, both examples exhibit scales which are so high (5.6244×10²³⁰) or so low (1.0088×10⁻²¹⁴), respectively, that they cannot be practically used in the FHE scheme.

TABLE 2
Highest-level scale calculated and initialized
for an exemplary modulus chain

| Chain index | Prime | Scale |
|---|---|---|
| 40 | 1073692673 | 1073672522.50147 |
| 39 | 1073668097 | 1073652372 |
| 38 | 1073655809 | 1073636648 |
| 37 | 1073651713 | 1073617487 |
| 36 | 1073643521 | 1073583263 |
| 35 | 1073569793 | 1073523008 |
| . . . | . . . | . . . |
| 5 | 1072078849 | 1072034254 |
| 4 | 1071947777 | 1071989661 |
| 3 | 1071882241 | 1072031547 |
| 2 | 1071861761 | 1072180874 |
| 1 | 1071751169 | 1072500083 |
| 0 | | 1073249520 |

TABLE 3
Scales reaching unreasonably high values
after rounding up the highest scale

| Chain index | Prime | Scale |
|---|---|---|
| 40 | 1073692673 | 1073672523 |
| 39 | 1073668097 | 1073652373 |
| 38 | 1073655809 | 1073636650 |
| 37 | 1073651713 | 1073617491 |
| 36 | 1073643521 | 1073583271 |
| 35 | 1073569793 | 1073523024 |
| . . . | . . . | . . . |
| 5 | 1072078849 | 9.09786E+15 |
| 4 | 1071947777 | 7.72061E+22 |
| 3 | 1071882241 | 5.56071E+36 |
| 2 | 1071861761 | 2.88478E+64 |
| 1 | 1071751169 | 7.764E+119 |
| 0 | | 5.6244E+230 |

TABLE 4
Scales reaching unreasonably low values
after rounding up the highest scale

| Chain index | Prime | Scale |
|---|---|---|
| 40 | 1073692673 | 1073672522 |
| 39 | 1073668097 | 1073652371 |
| 38 | 1073655809 | 1073636646 |
| 37 | 1073651713 | 1073617483 |
| 36 | 1073643521 | 1073583255 |
| 35 | 1073569793 | 1073522992 |
| . . . | . . . | . . . |
| 5 | 1072078849 | 114.9790134 |
| 4 | 1071947777 | 1.23313E−05 |
| 3 | 1071882241 | 1.41856E−19 |
| 2 | 1071861761 | 1.87736E−47 |
| 1 | 1071751169 | 3.2882E−103 |
| 0 | | 1.0088E−214 |

Reference is made back to the discussion of method 202, FIG. 5. In a step 208, scales may be calculated for all the levels below the highest level in the modulus chain, based on the scale initialized in step 206. The calculation may be performed, for example, according to formula 2.

In a step 210, during the computations performed by the FHE scheme, ciphertexts at one or more of the levels below the highest level in the modulus chain may be rescaled according to the scales calculated in step 208. The calculation may be performed, for example, according to formula 1. It should be noted that, in an FHE scheme, not all modulus chain levels are necessarily utilized. Rather, it is possible to begin arithmetic computations at a lower level, and not at the highest level. Accordingly, while scales may be calculated for all levels of the modulus chain (as prescribed by step 208), ciphertext rescaling may be performed only at a smaller number of levels—as the pertinent use case dictates.

In a step 212, responsive to encryption (by the FHE scheme) of a plaintext into a ciphertext at a certain level of the modulus chain (whether the highest level or any lower level), that ciphertext may be associated with (namely, stored in association with) the respective scale of that certain level, as calculated in step 208.

Each of steps 210 and 212 may be performed whenever operations by the FHE scheme require it; these steps are shown as parallel (in FIG. 5) merely to illustrate that they are not co-dependent.

Steps 208-212 are not necessarily performed as part of method 202. For example, method 202 may include only steps 204-206, and any subsequent scale calculation, ciphertext rescaling, and ciphertext association with a scale may be performed by software not being part of method 202, which software only receives the value that is output by step 206.

Method 202 may be part of a larger method in which extensive, deep computations are to be securely performed, using FHE, on certain data. For example, method 202 may be part of a method (also embodied as a system and a computer program product, similar to what has been described above regarding method 202) for machine learning training and/or inference, particularly machine learning using an artificial neural network (ANN). This may be especially advantageous when the ANN is a ‘deep’ neural network, containing three or more layers (and often more than 10 layers).

The machine learning method for inference may include encrypting, using FHE, the pertinent trained neural network as well as one or more test samples, and performing the computations prescribed by the various neural network layers using the pertinent FHE scheme. This may be referred to as performing “encrypted inference.” The output of these computations is the inference (prediction) of the neural network, which is provided as one or more ciphertexts. Since FHE was used, these output ciphertexts will encode approximately the same information as if inference were performed by an unencrypted version of the neural network on unencrypted versions of the test samples. Advantageously, the entity performing the computations is not exposed to the underlying data, namely—the unencrypted neural network, the unencrypted test samples, and the resulting inference. It is also possible to encrypt (using FHE) just the neural network but not the test samples, or just the test samples but not the neural network, depending on which one of these is desired to be kept secret.

The machine learning method for training, in turn, may include encrypting, using FHE, the pertinent untrained neural network as well as a training set which includes multiple training samples and labels associated with these samples, and performing the computations prescribed by the various neural network layers using the pertinent FHE scheme. This may be referred to as performing “encrypted training.” The output of these computations is essentially a trained, encrypted, neural network. As with the inference case, the entity performing these training computations is not exposed to the underlying data, namely—the unencrypted neural network, the unencrypted training set samples with their labels, and the unencrypted trained neural network. It is also possible not to encrypt the untrained neural network, but rather encrypt (using FHE) just the training set and the trained neural network, such as if secrecy of the untrained neural network (which typically includes some default architecture with default/random weights, which are nothing out of the ordinary) is not a concern.

In both the inference method and the training method, the encrypted result(s) of the computations may be transmitted back to the entity who requested the computations, and that entity may decrypt the results—be it the inference by the neural network (in the inference method) or the trained neural network (in the training method) and use them. Accordingly, these inference and training methods may be advantageous in scenarios where machine learning processing of secret and/or personal information is required, but the entity who owns (or is tasked with protecting) the secret/personal information must outsource the machine learning processing to an entity or a location at which the secrecy of the information cannot be guaranteed.

The term “personal information,” as used herein, refers to information about an individual person, including (1) information that can be used to distinguish or trace the individual's identity, such as name, government-issued identification number, date and place of birth, mother's maiden name, or biometric records; and (2) information that is linked or linkable to the individual, such as medical, educational, financial, and employment information.

The term “secret information,” as used herein, refers to information that is defined as secret by a certain entity, such as a business organization, a governmental organization, or an individual person.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method comprising, in a fully-homomorphic encryption (FHE) scheme that employs ciphertext rescaling at different levels of a modulus chain of prime numbers:
initializing a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

2. The method of claim 1, wherein the FHE scheme is CKKS.

3. The method of claim 1, wherein the value to which the scale of the highest level of the modulus chain is initialized further equals:
a multiplication of:
an arithmetic product of the prime numbers, each to the power of two, to the power of: the location of the respective prime number in the modulus chain, minus one,
by:
one divided by: two to the power of: the location of the respective prime number in the modulus chain, minus one.

4. The method of claim 1, further comprising:
obtaining the prime numbers of the modulus chain from a software library that implements the FHE scheme,
wherein the initialization is performed responsive to the obtaining.

5. The method of claim 1, further comprising:
calculating scales for all levels of the modulus chain which are lower than the highest level, based on the initialized scale of the highest level.

6. The method of claim 5, further comprising at least one of:
(a) according to the calculated scales, rescaling the ciphertexts at one or more levels of the modulus chain which are lower than the highest level, wherein, due to the initialization, the calculated scales are maintained within a range of values of the prime numbers; and
(b) responsive to encryption of a plaintext into a ciphertext at a certain level of the modulus chain, associating the encrypted ciphertext with the calculated scale of that certain level.

7. The method of claim 1, further comprising:
obtaining machine learning data that comprise:
a trained artificial neural network (ANN), and one or more test samples, or
an untrained ANN, and a training set;
encrypting at least some of the machine learning data using the FHE scheme; and
performing, respectively:
encrypted inference by the trained ANN, or
encrypted training of the untrained ANN.

8. A system comprising:
(a) at least one hardware processor; and
(b) a non-transitory computer-readable storage medium having program code embodied therewith, the program code executable by said at least one hardware processor to:
operate a fully-homomorphic encryption (FHE) scheme that employs ciphertext rescaling at different levels of a modulus chain of prime numbers; and
initialize a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

9. The system of claim 8, wherein the FHE scheme is CKKS.

10. The system of claim 8, wherein the value to which the scale of the highest level of the modulus chain is initialized further equals:
a multiplication of:
an arithmetic product of the prime numbers, each to the power of two, to the power of: the location of the respective prime number in the modulus chain, minus one,
by:
one divided by: two to the power of: the location of the respective prime number in the modulus chain, minus one.

11. The system of claim 8, wherein the program code is further executable to:
obtain the prime numbers of the modulus chain from a software library that implements the FHE scheme,
wherein the initialization is performed responsive to the obtaining.

12. The system of claim 8, wherein the program code is further executable to:
calculate scales for all levels of the modulus chain which are lower than the highest level, based on the initialized scale of the highest level.

13. The system of claim 12, wherein the program code is further executable to perform at least one of:
(a) according to the calculated scales, rescale the ciphertexts at one or more levels of the modulus chain which are lower than the highest level, wherein, due to the initialization, the calculated scales are maintained within a range of values of the prime numbers; and
(b) responsive to encryption of a plaintext into a ciphertext at a certain level of the modulus chain, associate the encrypted ciphertext with the calculated scale of that certain level.

14. The system of claim 8, wherein the program code is further executable to:
obtain machine learning data that comprise:
a trained artificial neural network (ANN), and one or more test samples, or
an untrained ANN, and a training set;
encrypt at least some of the machine learning data using the FHE scheme; and
perform, respectively:
encrypted inference by the trained ANN, or
encrypted training of the untrained ANN.

15. A computer program product comprising a non-transitory computer-readable storage medium having program code embodied therewith, the program code executable by at least one hardware processor to:
operate a fully-homomorphic encryption (FHE) scheme that employs ciphertext rescaling at different levels of a modulus chain of prime numbers; and
initialize a scale of the highest level of the modulus chain to a value that equals a weighted geometric mean of all the prime numbers, wherein, in the weighted geometric mean, the weight for each of the prime numbers is two to the power of: a location of the respective prime number in the modulus chain, minus one.

16. The computer program product of claim 15, wherein the value to which the scale of the highest level of the modulus chain is initialized further equals:
a multiplication of:
an arithmetic product of the prime numbers, each to the power of two, to the power of: the location of the respective prime number in the modulus chain, minus one,
by:
one divided by: two to the power of: the location of the respective prime number in the modulus chain, minus one.

17. The computer program product of claim 15, wherein the program code is further executable to:
obtain the prime numbers of the modulus chain from a software library that implements the FHE scheme,
wherein the initialization is performed responsive to the obtaining.

18. The computer program product of claim 15, wherein the program code is further executable to:
calculate scales for all levels of the modulus chain which are lower than the highest level, based on the initialized scale of the highest level.

19. The computer program product of claim 18, wherein the program code is further executable to perform at least one of:
(a) according to the calculated scales, rescale the ciphertexts at one or more levels of the modulus chain which are lower than the highest level, wherein, due to the initialization, the calculated scales are maintained within a range of values of the prime numbers; and
(b) responsive to encryption of a plaintext into a ciphertext at a certain level of the modulus chain, associate the encrypted ciphertext with the calculated scale of that certain level.

20. The computer program product of claim 15, wherein the program code is further executable to:
obtain machine learning data that comprise:
a trained artificial neural network (ANN), and one or more test samples, or
an untrained ANN, and a training set;
encrypt at least some of the machine learning data using the FHE scheme; and
perform, respectively:
encrypted inference by the trained ANN, or
encrypted training of the untrained ANN.
